(19) United States
(12) Patent Application Publication
(10) Pub. No.: US 2013/0087123 A1
(43) Pub. Date: Apr. 11, 2013

(54) DIESEL-GASOLINE HYBRID ENGINE

(71) Applicants: Minyoung Ki, Seoul (KR); Dae Choi, Hwaseong-si (KR); Hyunsung Jung, Anyang-si (KR); Hyeungwoo Lee, Suwon-si (KR)

(72) Inventors: Minyoung Ki, Seoul (KR); Dae Choi, Hwaseong-si (KR); Hyunsung Jung, Anyang-si (KR); Hyeungwoo Lee, Suwon-si (KR)

(73) Assignee: HYUNDAI MOTOR COMPANY, Seoul (KR)

(21) Appl. No.: 13/307,858

(22) Filed: Nov. 30, 2011

(30) Foreign Application Priority Data
Oct. 7, 2011 (KR) 10-2011-0102402

(51) Int. Cl. F02M 25/07; F02B 47/08

(52) U.S. Cl. 123/445

(57) ABSTRACT

A diesel-gasoline hybrid engine is constructed with an exhaust gas recirculation (EGR) system, without a design change. As a combustion space of a combustion chamber is stratified into a high-concentration EGR space and a relatively low-concentration EGR space, an ignition quality of a low-speed and low-load region is secured to improve combustion, and simultaneously, knocking in a high-low region is suppressed. Furthermore, the amount of NO_{X} generated during gasoline premixed combustion and smoke generated during diesel combustion are significantly reduced.

### CROSS-REFERENCE TO RELATED APPLICATIONS

The present application claims the priority of Korean Patent Application Number 10-2011-0102402 filed Oct. 7, 2011, the entire contents of which application is incorporated herein for all purposes by this reference.

### BACKGROUND OF INVENTION

1. Field of Invention

The present invention relates to a diesel-gasoline hybrid engine, and more particularly, to a diesel-gasoline hybrid engine which is capable of improving combustion in a low-speed and low-load region and suppressing knocking in a high-load region by stratifying the space of a combustion chamber into a high-concentration exhaust gas recirculation (EGR) space and a relatively low-concentration EGR space.

2. Description of Related Art

In general, a diesel engine compresses intake air at high temperate and high pressure by using a piston forming a combustion space, and burns the compressed air through an ignition of injected fuel, such that the piston is vertically reciprocated by an explosive power generated during the combustion.

Since the above-described diesel engine realizes the direct-injection compression ignition, the fuel combustion efficiency thereof is high. Therefore, fuel efficiency may be improved.

A gasoline engine introduces fuel and air, which are mixed at a constant ratio, into a combustion chamber space, and compresses the mixture. Then, the gasoline engine sparks a fire through a spark plug and burns the compressed mixture, such that a piston is vertically reciprocated by an explosive power generated during the combustion.

Therefore, the fuel combustion efficiency of the gasoline engine is relatively lower than that of the diesel engine, and thus the fuel efficiency of the gasoline engine is inevitably lower than that of the diesel engine.

Recently, as CO₂ is more and more strictly regulated and the demand for high fuel efficiency increases, a pollutant reduction is inevitably requested for the diesel engine, and a high compression ratio is inevitably requested for the gasoline engine.

However, the pollutant reduction of the diesel engine has a disadvantage in terms of cost. Furthermore, when the high compression ratio of the gasoline engine is achieved, it has an advantage in terms of fuel efficiency, but knocking may occur in a high-load region.

As a method for simultaneously satisfying the CO₂ regulation becoming strict more and more and the request for high fuel efficiency, a diesel-gasoline hybrid engine having the advantages of the diesel engine and the gasoline engine has been developed.

The most specific characteristic of the diesel-gasoline hybrid engine lies in a combustion process. For example, gasoline fuel and air are premixed during an intake stroke, and diesel fuel for controlling ignition instead of a spark plug is injected and self-ignited, during a compression stroke. Accordingly, the gasoline fuel is burned by an ignition action of the self-ignited diesel fuel.

Accordingly, the diesel-gasoline hybrid engine as a gasoline engine may improve the fuel efficiency through a high compression ratio, and simultaneously, significantly reduce smoke (NO_{X}) in comparison with the diesel engine. In particular, since a diesel particulate filter (DPF) is not applied and a low-price injection system is applied in comparison with the diesel engine, the diesel-gasoline hybrid engine has an advantage in terms of cost.

However, the diesel-gasoline hybrid engine basically achieves a high compression ratio based on the gasoline engine. Therefore, there are difficulties in securing an ignition quality in a low-load region, and the diesel-gasoline hybrid engine is inevitably vulnerable to knocking in a high-load region, as described above.

In order to relieve knocking in a high-load region, a method using an EGR system as an exhaust gas recirculation system may be applied to supply exhaust gas to a combustion chamber of the diesel-gasoline hybrid engine. This method uses such a characteristic that, as the concentration of exhaust gas in the combustion chamber increases, the temperature of flames decreases, and simultaneously, the concentration of oxygen decreases.

Accordingly, it is possible to reduce nitrogen oxides which easily occur under a condition of high temperature and high oxygen concentration, and to relieve knocking in a high load region.

However, the diesel-gasoline hybrid engine including the EGR system may have a technical limitation in relieving knocking in a high load region. Nevertheless, the method using the EGR system to relieve knocking in a high load region has effectiveness at a current technology level.

Therefore, there is an urgent demand for a method which includes a diesel-gasoline hybrid engine with an EGR system and is capable of relieving difficulties in securing an ignition quality in a low-load region and knocking in a high-load region.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a diesel-gasoline hybrid engine which is capable of securing an ignition quality of a low-speed and low-load region to improve fuel efficiency, suppressing knocking in a high-load region, and reducing the amount of nitrogen oxides (NO_{X}) occurring while gasoline is premixed, by stratifying the space of a combustion chamber into a high-concentration EGR space and a relatively low-concentration EGR space.

Various aspects of the present invention provide for a diesel-gasoline hybrid engine, including: a combustion chamber having an exhaust port for discharging exhaust gas and formed in a cylinder coupled to a cylinder head such that a piston reciprocates in the combustion chamber; an EGR intake port having a tangential port for supplying gas mixed at a low EGR rate and a helical port for supplying gas mixed at a high EGR rate; an intake valve having a tangential valve which is provided in the tangential port and whose opening and closing are controlled and a helical valve which is provided in the helical port and whose opening and closing are controlled; a gasoline injector provided in an intake manifold and injecting gasoline fuel to intake air; and a diesel injector provided in the cylinder head and directly injecting diesel fuel to the combustion chamber to spark a fire.

The EGR intake port may be connected to the intake manifold which mixes EGR gas with air to control an EGR concentration with respect to the air.

The EGR intake port and the exhaust port may be arranged in parts of the combustion chamber, respectively, which are bisected along a horizontal center line of the combustion chamber.

The EGR intake port and the exhaust port may be arranged in parts of the combustion chamber, respectively, which are bisected along a vertical center line of the combustion chamber.

The diesel injector may be provided between the tangential valve and the helical valve.

In the combustion space of the combustion chamber, the gas mixed at a low EGR rate may be positioned at an upper portion of the cylinder, and the gas mixed at a high EGR rate may be positioned at a lower portion of the cylinder.

The diesel injector may directly inject diesel fuel into the combustion space of the combustion chamber to start combustion through a compression ignition.

In the combustion space of the combustion chamber, self-ignition of the diesel fuel may occur at the upper portion of the cylinder, and gasoline combustion may occur at the lower portion of the cylinder.

According to various aspects of the present invention, as the space of the combustion chamber is stratified into a high-concentration EGR space and a relatively low-concentration EGR space, an ignition quality in a low-speed and low-load region may be secured to improve combustion, and simultaneously, knocking in a high-load region may be suppressed. Furthermore, the amount of NO_{X} generated during gasoline premixed combustion may be reduced.

Furthermore, the performance of the entire load region from the low-load region to the high-load region may be improved to reduce smoke generated during diesel combustion, even in the intermediate and high-load region.

Furthermore, the performance of the entire load region may be improved without a large variation in the construction of the diesel-gasoline hybrid engine and the EGR system, which makes it possible to significantly increase the effectiveness and merchantability of the EGR system and the diesel-gasoline hybrid engine.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 illustrates the construction around a combustion chamber of an exemplary diesel-gasoline hybrid engine according to the present invention.

FIG. 2 illustrates the cross-sectional construction of a combustion chamber of an exemplary diesel-gasoline hybrid engine according to the present invention.

FIGS. 3 to 5 illustrate examples of an intake manifold for controlling the concentration of EGR gas mixed with air in an exemplary diesel-gasoline hybrid engine according to the present invention.

FIG. 6 illustrates an operation state in the combustion chamber of an exemplary diesel-gasoline hybrid engine according to the present invention.

FIG. 7 illustrates a combustion propagation phase based on FIG. 6.

FIG. 8 illustrates a modification of the construction around the combustion chamber of an exemplary diesel-gasoline hybrid engine according to the present invention.

FIG. 9 illustrates a combustion propagation phase based on FIG. 8.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

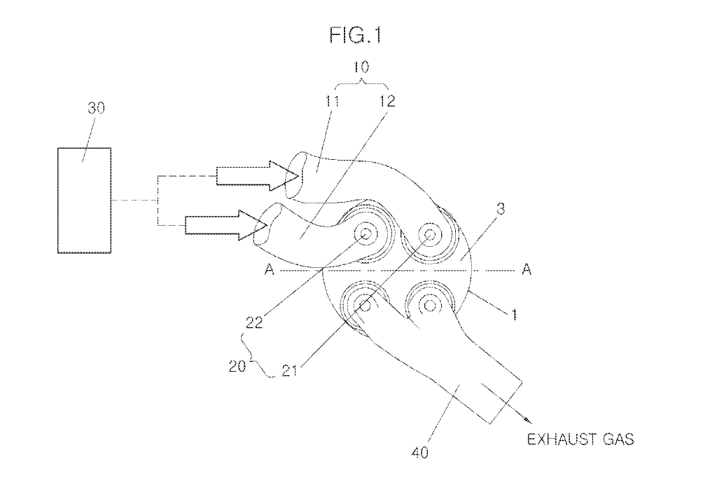

Referring to FIG. 1, the diesel-gasoline hybrid engine includes a cylinder 1, a combustion chamber 3, an EGR intake port 10, an intake valve 20, an intake manifold 30, and an exhaust port 40. Combustion chamber 3 is formed in cylinder 1 so as to construct a combustion space. EGR intake port 10 is connected to combustion chamber 3, differentiates the concentration of EGR gas mixed with air, and supplies the mixture to combustion chamber 3. Intake valve 20 is provided in EGR intake port 10 such that the opening and closing thereof is controlled. Intake manifold 30 is connected to control the concentration of the mixture of external air and EGR gas and supply the mixture to EGR intake port 10. Exhaust port 40 is connected to combustion chamber 3 and discharge exhaust gas after combustion.

Combustion chamber 3 serves as a combustion space applied to a gasoline engine.

EGR intake port 10 includes a tangential port 11 for supplying EGR gas having a lower concentration than air and a helical port 12 for supplying EGR gas having a higher concentration than air. The ports diverge from intake manifold 30 and are connected to the upper surface of combustion chamber 3.

Depending on cases, however, the EGR intake port may be modified in such a manner that the EGR gas having a higher concentration than air is supplied from tangential port 11 and the EGR gas having a lower concentration than air is supplied from helical port 12.

The respective ports of exhaust manifold 40 diverging from intake manifold 30 are connected to the upper surface of combustion chamber 3 and then joined to each other.

In this exemplary embodiment, EGR intake port 10 and exhaust port 40 may be arranged in various manners with respect to the center of combustion chamber 3. FIG. 1 illustrates a case in which EGR intake port 10 is positioned over a horizontal center line A-A of combustion chamber 3 and exhaust port 40 is positioned under the horizontal center line A-A.

However, EGR intake port 10 may also be positioned under the horizontal center line A-A of combustion chamber 3 and exhaust port 40 may be positioned over the horizontal center line A-A.

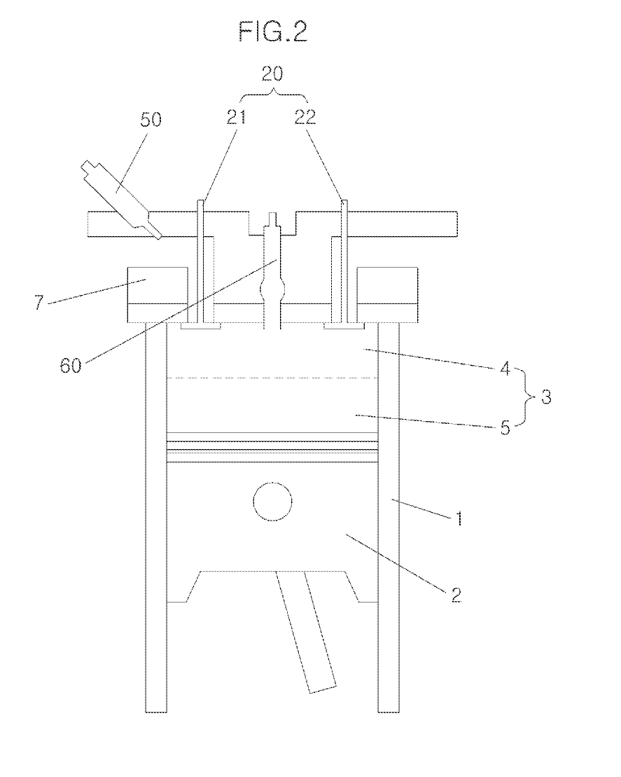

Referring to FIG. 2, combustion chamber 3 formed in cylinder 1 is sealed by a cylinder head 7 coupled vertically to combustion chamber 3 and forms a combustion space. The combustion space is divided into an upper combustion space 4 and a lower combustion space 5. Upper combustion space 4 is filled with low-concentration EGR gas supplied through tangential port 11, while forming an upper portion of the combustion space. Lower combustion space 4 is filled with high-concentration EGR gas supplied through helical port 12, while forming a lower portion of the combustion space.

As combustion chamber 3 is divided in upper combustion space 4 and lower combustion space 5, stratification in which low-concentration EGR gas fills the upper part and high-concentration EGR gas fills the lower part may be achieved, even though the upper and lower combustion spaces are integrated with each other.

Accordingly, a design change for the structure of the combustion chamber of the gasoline engine is not requested in various embodiments of the present invention.

Typically, the volumes of upper combustion space 4 and lower combustion space 5 of combustion chamber 3 are varied according to the compression stroke and the expansion stroke of piston 2.

Exhaust valve 20 includes a tangential valve 21 installed in tangential port 11 and a helical valve 12 installed in helical port 12, and has such a structure that the respective valves are biased to the left and right portions of the space of the combustion chamber with respect to combustion chamber 3.

Furthermore, exhaust port 40 includes an exhaust valve of which the opening and closing are controlled.

The diesel-gasoline hybrid engine according to various embodiments of the present invention further includes a gasoline injector 50 and a diesel injector 60. Gasoline injector 50 is provided in the exhaust manifold and injects gasoline fuel to intake air. Diesel injector 60 injects diesel fuel to combustion chamber 3 to spark a fire.

Gasoline injector 50 may inject fuel to the combustion space of combustion chamber 3 when intake value 20 is opened, similar to a method applied to a typical gasoline engine.

Diesel injector 60 directly injects diesel fuel to the combustion space of combustion chamber 3 regardless of the opening and closing of intake valve 20 and an ignition is caused by high temperature. This is identical to a method applied to a typical diesel engine.

The combustion control of the diesel-gasoline hybrid engine according to various embodiments of the present invention is implemented by an engine control unit (ECU) which is a controller of a vehicle. As a control logic for this structure, a typical combustion control logic implemented in the diesel-gasoline hybrid engine including the EGR system is applied. If necessary, control for the opening and closing time of intake valve 20, control for intake manifold 30, or control for the injection time of gasoline injector 50 or diesel injector 60 may be properly changed.

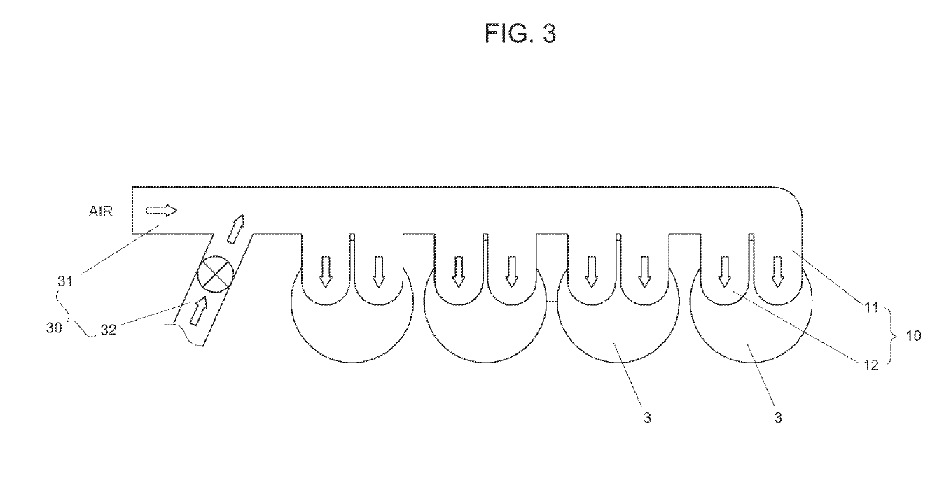

FIGS. 3 to 5 illustrate constitution examples of the intake manifold for controlling the concentration of EGR gas mixed with air in the diesel-gasoline hybrid engine according to various embodiments of the present invention.

An intake manifold 30 illustrated in FIG. 3 includes one air introduction line 31 having a throttle valve and an EGR manifold 32 having an EGR value for controlling the amount of EGR gas and connected to air introduction line 31.

In this case, tangential port 11 and helical port 12 connected to each combustion chamber 3 receive EGR gases having different concentrations from the air from one intake manifold 30, and fill the combustion space with stratified EGR gases having different concentrations.

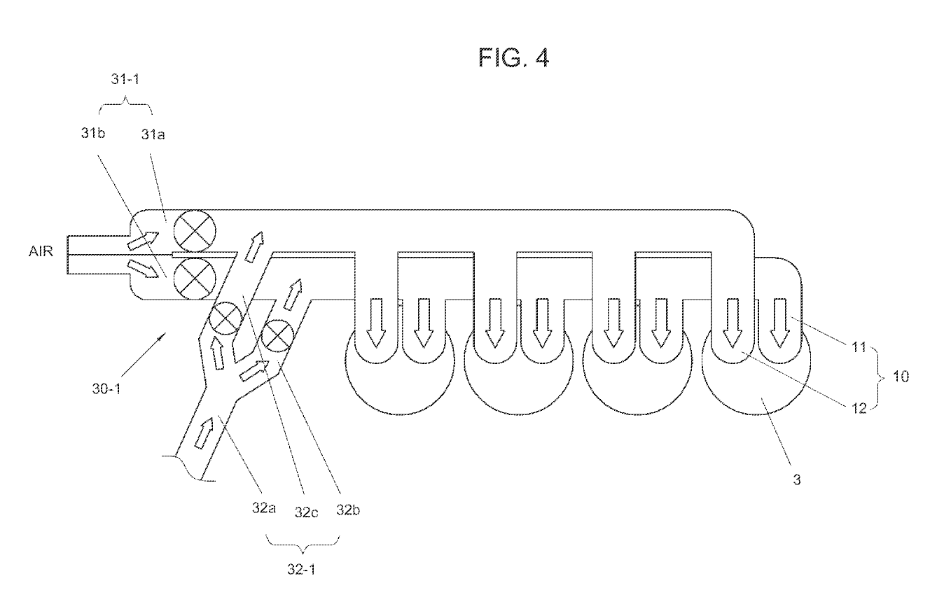

An intake manifold 30-1 illustrated in FIG. 4 includes an air introduction line 31-1 and an EGR manifold 32-1. Air introduction line 31-1 includes first and second introduction lines 31a and 31b each having a throttle vale. EGR manifold 32-1 includes a main EGR line 32a through which EGR gas flows and first and second EGR branch lines 32b and 32c diverging from main EGR line 32a, connected to first and second introduction lines 31a and 31b, respectively, and each having an EGR valve.

In this case, tangential port 11 and helical port 12 connected to each combustion chamber 3 receive EGR gases having different concentrations from the air, from intake manifold 30-1 having air introduction line 31-1 divided into two parts, and fill the combustion space with stratified EGR gases having different concentrations.

Intake manifold 30-1 having such a structure has an advantage of more easily achieving EGR stratification in the combustion space of combustion chamber 3, compared with intake manifold 30 described above.

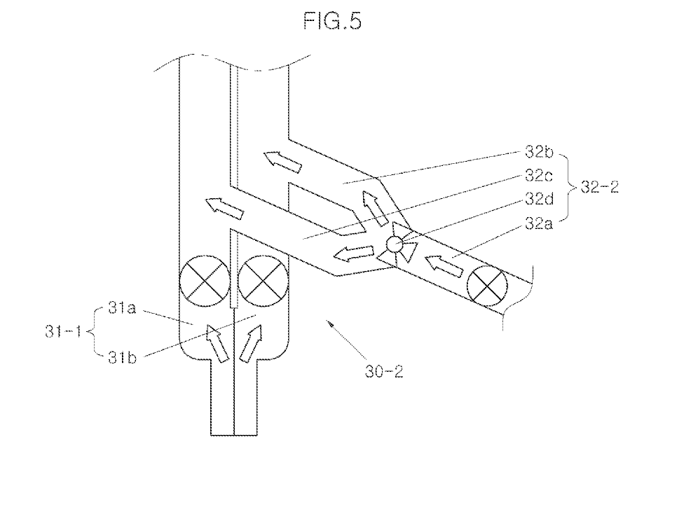

An intake manifold 30-2 illustrated in FIG. 5 includes an intake introduction line 31-1 having first and second introduction lines 31a and 31b, like intake manifold 30-1 of FIG. 4 described above. However, intake manifold 30-2 has a different structure in terms of an EGR manifold 32-2 through which EGR gas flows.

For example, EGR manifold 32-2 includes a main EGR line 32a passing EGR gas and having an EGR valve and first and second EGR branch lines 32b and 32c diverging from main EGR line 32a, connected to first and second introduction lines 31a and 31b, respectively, and having no EGR valve. Furthermore, EGR manifold 32-2 includes a three-way valve 33d provided at main EGR line 32a and the diverging portion of first and second EGR branch lines 32b and 32c.

In this case, intake manifold 30-2 exhibits the same performance as intake manifold 30-1 described above in terms of the stratified EGR formation within the combustion space, but the number of EGR valves may be reduced.

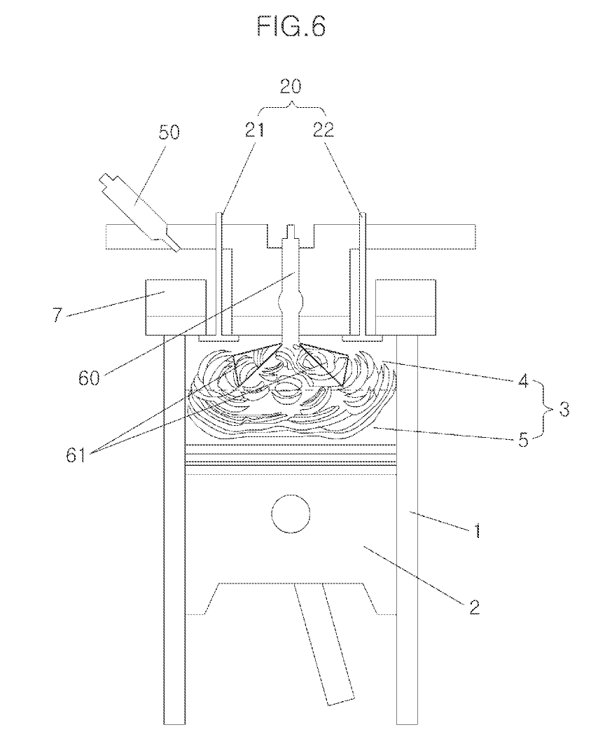

FIG. 6 illustrates an operation state in the combustion chamber of the diesel-gasoline hybrid engine according to various embodiments of the present invention.

When the engine is driven, EGR gases mixed with air are supplied at different concentrations to intake port 10 from intake manifold 30, 30-1, or 30-2 as illustrated in FIG. 6, in a state in which exhaust port 40 is closed.

Low-concentration EGR gas supplied through tangential port 11 of EGR intake port 10 fills upper combustion space 4 of combustion chamber 3, and high-concentration EGR gas supplied through helical port 12 of EGR intake port 10 fills low combustion space 5 of combustion chamber 3.

At this time, the time points at which high-concentration EGR gas and low-concentration EGR gas are introduced into combustion chamber 3 are controlled by the control of the opening and closing times of tangential valve 21 provided in tangential port 11 and the opening and closing times of helical valve 22 provided in helical port 12.

In this exemplary embodiment, however, when the high-concentration EGR gas and the low-concentration EGR gas are supplied to combustion chamber 3, gasoline fuel is supplied to combustion chamber 3 through gasoline injector 50 in case where tangential valve 21 or helical valve 22 is opened, but diesel fuel is not supplied.

This is because diesel fuel injected to combustion chamber 3 from diesel injector 60 requires a compression stroke of piston 2 since a high temperature is required to spark a fire for combustion.

Subsequently, when combustion chamber 3 is sufficiently heated and pressurized, diesel injector 60 injects diesel fuel to combustion chamber 3 such that piston 2 descends with an explosion in the combustion space.

The diesel-gasoline hybrid engine including the EGR system in accordance with various embodiments of the present invention repeats the above-described combustion stroke to generate an engine power.

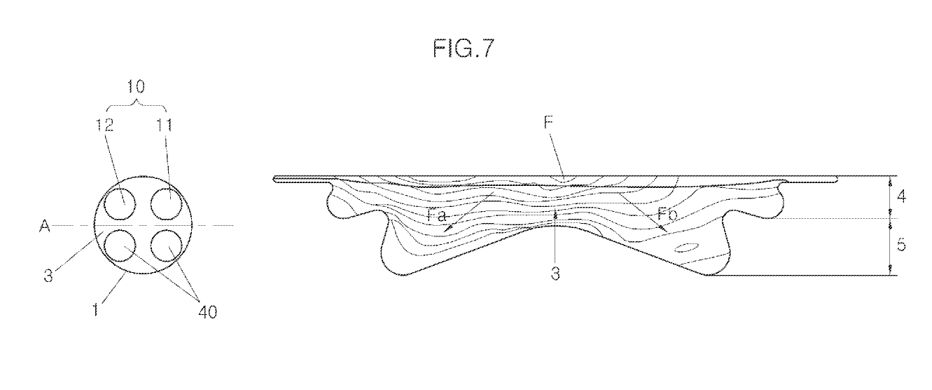

FIG. 7 illustrates a case in which EGR intake port 10 is positioned over the horizontal center line A-A of combustion chamber 3 and exhaust port 40 is positioned under the horizontal center line A-A. FIG. 7 shows a CFD (Computational Fluid Dynamics) flow analysis for combustion propagation phase based on FIG. 6.

As illustrated in FIG. 7, when diesel fuel injected from the diesel injector 60 is ignited (F), flame flows Fa and Fb spreading from the ignition F through upper combustion space 4 to lower combustion space 5 are formed in combustion chamber 3.

As the combustion is performed in such a manner that the flame flows Fa and Fb uniformly spread in all directions of combustion chamber 3, an ignition quality is easily secured in a low-load region, and knocking does not occur in a high-load region, even at a high compression ratio.

In particular, as the combustion performance in the entire load region from the low-load region to the high-load region is significantly improved, the amount of NO_{X} generated during gasoline premixed combustion may be reduced, and smoke generated during diesel combustion may be reduced in the high-load region.

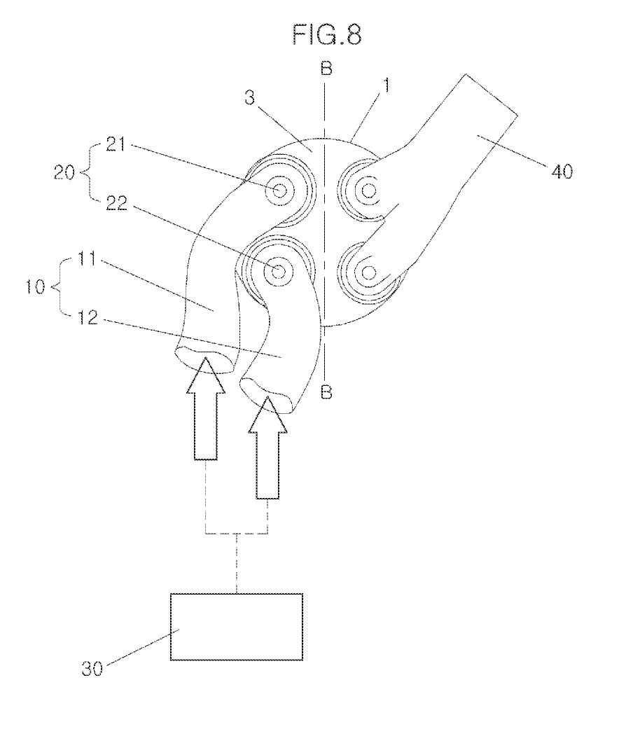

FIG. 8 illustrates a modification of the construction around the combustion chamber of the diesel-gasoline hybrid engine according to various embodiments of the present invention.

As illustrated in FIG. 8, the diesel-gasoline hybrid engine according to the modification is constructed in a similar manner to the case where EGR intake port 10 is positioned over the horizontal center line A-A of combustion chamber 3 and exhaust port 40 is positioned under the horizontal center line A-A. In the diesel-gasoline hybrid engine according to the modification, however, EGR intake port 10 is positioned in one side (right side) with respect to a vertical center line B-B of combustion chamber 3 and exhaust gas 40 is positioned in the opposite side (left side). That is, the diesel-gasoline hybrid engine according to the modification has a different layout.

On the other hand, EGR intake port 10 may be positioned in one side (left side) with respect to the vertical center line B-B of combustion 3, and exhaust port 40 may be positioned in the opposite side (right side).

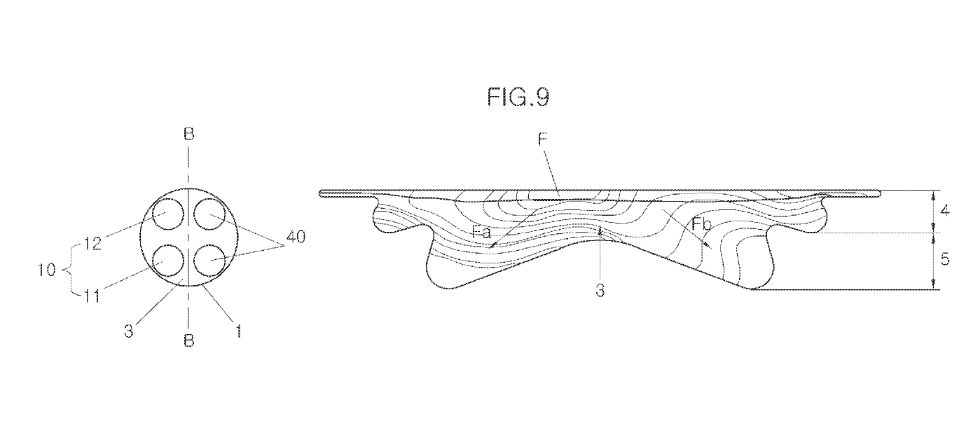

FIG. 9 illustrates a CFD flow analysis for combustion propagation phase based on FIG. 8.

As illustrated in FIG. 9, when diesel fuel injected from diesel injector 60 is ignited (F), flame flows Fa and Fb spreading from the ignition F through upper combustion space 4 to lower combustion space 5 are formed in combustion chamber 3. In this case, the shapes of the flame flows Fa and Fb spreading in all directions of combustion chamber 3 may have a minute difference.

However, an influence caused by the above-described minute difference of the flame flows Fa and Fb is very small. Therefore, even in this case, an ignition quality is easily secured in a low-load region, and knocking does not occur in a high-load region, even at a high compression ratio.

Furthermore, as the combustion performance in the entire load region from the low-load region to the high-load region is significantly improved, the amount of NO_{X} generated during gasoline premixed combustion may be reduced, and smoke generated during diesel combustion may be reduced in the high-load region.

As described above, the diesel-gasoline hybrid engine according to various embodiments of the present invention may be constructed with the EGR system without a design change, and may stratify the combustion space of combustion chamber 3 into the high-concentration EGR space and the relatively low-concentration EGR space. Therefore, the ignition quality of the low-speed and low-load region may be secured to improve the combustion and simultaneously suppress knocking of the high-load region. Furthermore, the amount of NO_{X} generated during gasoline premixed combustion and smoke generated during diesel combustion may be significantly reduced.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A diesel-gasoline hybrid engine, comprising:
a combustion chamber comprising an exhaust port for discharging exhaust gas and formed in a cylinder coupled to a cylinder head such that a piston reciprocates in the combustion chamber;
an exhaust gas recirculation (EGR) intake port comprising a tangential port for supplying gas mixed at a low EGR rate and a helical port for supplying gas mixed at a high EGR rate;
an intake valve comprising a tangential valve which is provided in the tangential port and whose opening and closing are controlled and a helical valve which is provided in the helical port and whose opening and closing are controlled;
a gasoline injector provided in an intake manifold and injecting gasoline fuel to intake air; and
a diesel injector provided in the cylinder head and directly injecting diesel fuel to the combustion chamber to spark a fire.

2. The diesel-gasoline hybrid engine as defined in claim 1, wherein the EGR intake port is connected to the intake manifold which mixes EGR gas with air to control an EGR concentration with respect to the air.

3. The diesel-gasoline hybrid engine as defined in claim 2, wherein the EGR intake port and the exhaust port are arranged in parts of the combustion chamber, respectively, which are bisected along a horizontal center line of the combustion chamber.

4. The diesel-gasoline hybrid engine as defined in claim 2, wherein the EGR intake port and the exhaust port are arranged in parts of the combustion chamber, respectively, which are bisected along a vertical center line of the combustion chamber.

5. The diesel-gasoline hybrid engine as defined in claim 3, wherein, in the combustion space of the combustion chamber, the gas mixed at a low EGR rate is positioned at an upper portion of the cylinder, and the gas mixed at a high EGR rate is positioned at a lower portion of the cylinder.

6. The diesel-gasoline hybrid engine as defined in claim 5, wherein the diesel injector is provided between the tangential valve and the helical valve.

7. The diesel-gasoline hybrid engine as defined in claim 6, wherein the diesel injector directly injects diesel fuel into the combustion space of the combustion chamber to start combustion through a compression ignition.

8. The diesel-gasoline hybrid engine as defined in claim 7, wherein, in the combustion space of the combustion chamber, self-ignition of the diesel fuel occurs at the upper portion of the cylinder, and gasoline combustion occurs at the lower portion of the cylinder.
